(19) United States
(12) Patent Application Publication
(10) Pub. No.: US 2020/0051520 A1
(43) Pub. Date: Feb. 13, 2020

(54) DISPLAY DEVICE

(71) Applicant: HKC CORPORATION LIMITED, SHUITIAN VILLAGE, SHIYAN SUB (CN)

(72) Inventor: JIANFENG SHAN, SHUITIAN VILLAGE, SHIYANS SUB-DISTRICT (CN)

(21) Appl. No.: 16/482,240

(22) PCT Filed: Dec. 14, 2017
(86) PCT No.: PCT/CN2017/116241

§ 371 Date: Jul. 30, 2019

(30) Foreign Application Priority Data
Oct. 26, 2017 (CN) 201711022782.9

(51) Int. Cl. G09G 3/36

(52) U.S. Cl. CPC G09G 3/3696; G09G 3/3648; G09G 2320/0247; G09G 2320/0257; G09G 2320/0219

(57) ABSTRACT

The disclosure illustrates a display device comprising: pixels arranged in a matrix form; image signal lines providing data signals to the pixels; scan signal lines crossing the image signal lines; a gate driver circuit configured to output a scan signal to the plurality of scan signal lines, and drive the scan signal lines by the scan signal; and a control circuit configured to control the gate driver circuit through a control signal comprising voltage waveform with voltage variation cycles. When a scan cycle of the scan signal is started, a voltage level of the scan signal non-vertically rises from a first voltage level to a second voltage level, and the voltage level of the scan signal is maintained at the second voltage levels, and when the scan cycles is ended, the voltage level of the scan signal non-vertically falls from the second voltage level to the first voltage level.

### CROSS-REFERENCE TO RELATED APPLICATION

This application claims the benefit of China Patent Application No. 201711022782.9, filed on Oct. 26, 2017, in the State Intellectual Property Office of the People's Republic of China, the disclosure of which is incorporated herein in its entirety by reference.

### BACKGROUND

### 1. Field

The present disclosure relates to the matrix-type liquid crystal display device and a display method thereof, more particularly to a display device (such as a LCD device) and a display method, and each display pixel of display device includes thin-film transistors served as switch devices.

### 2. Description of the Related Art

The LCD devices are widely applied to many display devices such as television or graphic display device. Each display pixel include a thin-film transistor (hereafter refer to as TFT) served as a switch device, so that the adjacent display pixels are not interfered with each other, thereby preventing a crosstalk image under a condition that a number of the display pixels are increased greatly. Existing LCD device includes a LCD panel and a driver circuit part. In the LCD panel, liquid crystal compositions are sealed between two electrode substrates. A deflection plate is disposed on an outer surface of the electrode substrate.

The TFT array substrate can be a transparent insulation substrate including a plurality of signal lines and a plurality of scan lines formed in a matrix form thereon; for example, the transparent insulation substrate can be glass. A switch device is disposed at each intersection between the signal line and the scan line, and can be formed by the TFT electrically connected to the pixel electrode. An alignment film is used to cover all above-mentioned components. On the other hand, the counter substrate served as the other electrode substrate is formed by the counter electrode and the alignment film laminated with each other, and the counter substrate is made by almost completely transparent insulation substrate, such as the glass substrate. The counter substrate is severed as a TFT array substrate. The driver circuit part includes a scan signal line driver circuit, a signal line driver circuit and a counter electrode driver circuit which are electrically connected to the scan lines, the signal lines and the counter electrodes of the display panel, respectively. The control circuit is configured to control the signal line driver circuit and the scan signal line driver circuit.

In the equivalent circuit for the transmission in consideration of the signal transmission delay of the scan signal line, the parasitic capacitance includes the crossing capacitance generated at the crossover point between the scan signal line and the signal line. so that the scan signal line may become a signal delay transmission path. The parasitic capacitance inside the display panel causes non uniform offsets of the pixel voltages in entire display panel; furthermore, when the LCD device has a larger screen and higher resolution, it is hard to ignore the voltage offsets caused by transmission delay. As a result, a conventional solution of biasing a common voltage is unable to absorb the differences between the voltage offsets in entire display panel, and the pixels of the display panel cannot be driven by AC field optimally, so that the display panel may have the defects of flashing and residual image because of applying the AC field.

### SUMMARY

An objective of the present disclosure is to provide a display device which is able to suppress the parasitic capacitance and the flashing problem due to variation of pixel voltage, so as to achieve high-definition and high performance.

According to an embodiment, the present disclosure provides a display device comprising: a plurality of pixels arranged in a matrix form; a plurality of image signal lines configured to provide a plurality of data signals to the plurality of pixels; a plurality of scan signal lines crossing the plurality of image signal lines; a gate driver circuit configured to output a scan signal to the plurality of scan signal lines, and drive the plurality of scan signal lines by the scan signal; and a control circuit configured to control the gate driver circuit through a control signal, wherein the control signal comprises voltage waveform with voltage variation cycles. When at least one of scan cycles of the scan signal is started, a voltage level of the scan signal non-vertically rises from a first voltage level to a second voltage level, and the voltage level of the scan signal is maintained at the second voltage levels, and when at least one of the scan cycles is ended, the voltage level of the scan signal non-vertically falls from the second voltage level to the first voltage level.

Optimally, the control circuits inputs the control signal to the gate driver circuit, to change a part of the variation between the second voltage level and the first voltage level of the scan signal.

Optimally, the voltage level of the scan signal non-vertically rises from the first voltage level to the second voltage level with a first slope, and the voltage level of the scan signal non-vertically falls from the second voltage level to the first voltage level with a second slope, and the first slope is higher than the second slope.

Optimally, the voltage level of the scan signal non-vertically rises from the first voltage level to the second voltage level with a first slope, and the voltage level of the scan signal non-vertically falls from the second voltage level to the first voltage level with a second slope, and the first slope is lower than the second slope.

Optimally, the gate driver circuit comprises a shift register part formed by a plurality of triggers cascaded with each other, and a plurality of selection switches turned on or off respectively according to output signals of the plurality of triggers.

Optimally, a number of the triggers is the same as that of the selection switches.

Optimally, in response to a clock signal, a plurality of gate start signals are transmitted through the plurality of triggers sequentially and outputted to the plurality of selection switches sequentially, to turn off the plurality of selection switches sequentially.

Optimally, the control circuit comprises a plurality of slew rate control components disposed between the plurality of selection switches and the plurality of triggers respectively, and configured to control impedances of output terminals of the gate driver, to increase the output impedances only during rising and falling parts of the scan signals.

Optimally, the display device further comprises a capacitor electrically connected to an input terminal of the gate driver, and a voltage source electrically connected to the input terminal of the gate driver through a first switch, and a resistor electrically connected in parallel with the capacitor through a second switch.

Optimally, the control circuit comprises an inverter configured to control turning on/off operation of the first switch through a charge-discharge control signal which is inverted by the inverter to control the turning on/off operation of the second switch.

Optimally, the charge-discharge control signal is synchronous with the clock signal.

Optimally, when the charge-discharge control signal is at the second voltage level, the first switch is turned on, and the second switch is turned off by the first voltage level applied by the inverter, so that the capacitor is charged.

Optimally, when the charge-discharge control signal is at the first voltage level, the first switch is turned off and the second switch is turned on by the second voltage level applied by the inverter, so that the capacitor is discharged through the resistor.

According to an embodiment, the present disclosure provides a display device, comprising: a plurality of pixels arranged in a matrix forms; a plurality of image signal lines configured to provide a plurality of data signals to the plurality of pixels; a plurality of scan signal lines crossing the plurality of image signal lines; a gate driver circuit configured to output a scan signal to the plurality of scan signal lines, to drive the plurality of scan signal lines; a control circuit configured to control the gate driver circuit through a control signal, wherein the control signal comprises voltage waveform with the voltage variation cycle; and a capacitor electrically connected to an input terminal of the gate driver, wherein a voltage source electrically connected to the input terminal of the gate driver through a first switch, and a resistor electrically connected in parallel with the capacitor through a second switch. When at least one of scan cycles of the scan signal is started, a voltage level of the scan signal non-vertically rises from a first voltage level to a second voltage level, and the voltage level of the scan signal is maintained at the second voltage level, and when at least one of the scan cycles is ended, the voltage level of the scan signal non-vertically falls from the second voltage level to the first voltage level. The control circuit comprises an inverter configured to control turning on/off operation of the first switch through a charge-discharge control signal, and the charge-discharge control signal is inverted by the inverter to control turn on/off operation of the second switch, and when the charge-discharge control signal is at the second voltage level, the first switch is turned on, and the second switch is turned off by the first voltage level applied by the inverter, so that the capacitor is charged, and when the charge-discharge control signal is at the second voltage level, the first switch is turned off, and the second switch is turned on by the first voltage level applied by the inverter, so that the capacitor is discharged.

Optimally, the voltage level of the scan signal non-vertically rises from the first voltage level to the second voltage level with a first slope, and the voltage level of the scan signal non-vertically falls from the second voltage level to the first voltage level with a second slope, and the first slope is higher than the second slope.

Optimally, a number of the plurality of image signal lines is the same as a number of the plurality of scan signal lines.

Optimally, the plurality of the data signals are synchronously provided to the plurality of pixels through the plurality of image signal lines.

Optimally, the gate driver circuit synchronously outputs the plurality of scan signals to drive the plurality of scan signal lines synchronously.

Optimally, the display device further comprises a counter electrode driver circuit, wherein a pixel capacitor and an auxiliary capacitor of each of the plurality of pixels are electrically connected in parallel with to a common voltage terminal of the counter electrode driver circuit.

According to an embodiment, the present disclosure provides a display device, comprising: a plurality of pixels arranged in a matrix forms; a plurality of image signal lines configured to provide a plurality of data signals to the plurality of pixels; a plurality of scan signal lines crossing the plurality of image signal lines; a gate driver circuit configured to output the plurality of scan signals to the plurality of scan signal lines, to drive the plurality of scan signal lines; a control circuit configured to control the gate driver circuit through a control signal, wherein the control signal comprises a voltage waveform level with voltage variation cycles; and a capacitor electrically connected to the input terminal of the gate driver, a voltage source electrically connected to the input terminal of the gate driver through the first switch, the resistor electrically connected in parallel with the capacitor through the second switch. When at least one of scan cycles of the scan signal is started, the voltage level of the scan signal non-vertically rises from the first voltage level to the second voltage level, and the voltage level of the scan signal is maintained at the second voltage level, and when at least one of scan cycles is ended, the voltage level of the scan signal non-vertically falls from the second voltage level to the first voltage level. The control circuits inputs the control signal to the gate driver circuit, to change a part of the variation between the second voltage level and the first voltage level of the scan signal. The voltage level of the scan signal non-vertically rises from the first voltage level to the second voltage level with a first slope, and the voltage level of the scan signal non-vertically falls from the second voltage level to the first voltage level with a second slope, and the first slope is higher than the second slope, and the first slope is different from the second slope. The gate driver circuit comprises a shift register part formed by a plurality of triggers cascaded with each other, and the plurality of selection switches are turned on or off respectively according to output signals of the plurality of triggers.

According to an embodiment, the present disclosure provides a display device comprising: a plurality of pixels arranged in a matrix form; a plurality of image signal lines configured to provide a plurality of data signals to the plurality of pixels; a plurality of scan signal lines crossing the plurality of image signal lines; a gate driver circuit configured to output a scan signal to the plurality of scan signal lines, and drive the plurality of scan signal lines by the scan signal; and a control circuit configured to control the gate driver circuit through a control signal, wherein the control signal comprises voltage waveform with voltage variation cycles. When at least one of scan cycles of the scan signal is started, a voltage level of the scan signal rises from a first voltage level to a second voltage level with a curvature of a convex parabola. When at least one of the scan cycles is ended, the voltage level of the scan signal non-vertically falls from the second voltage level to the first voltage level.

According to an embodiment, the present disclosure provides a display device comprising: a plurality of pixels arranged in a matrix form; a plurality of image signal lines configured to provide a plurality of data signals to the plurality of pixels; a plurality of scan signal lines crossing the plurality of image signal lines; a gate driver circuit configured to output a scan signal to the plurality of scan signal lines, and drive the plurality of scan signal lines by the scan signal; and a control circuit configured to control the gate driver circuit through a control signal, wherein the control signal comprises voltage waveform with voltage variation cycles. When at least one of scan cycles of the scan signal is started, a voltage level of the scan signal non-vertically rises from a first voltage level to a second voltage level. when at least one of the scan cycles is ended, the voltage level of the scan signal non-vertically falls from the second voltage level to the first voltage level with a curvature of a concave parabola.

According to an embodiment, the present disclosure provides a display device comprising: a plurality of pixels arranged in a matrix form; a plurality of image signal lines configured to provide a plurality of data signals to the plurality of pixels; a plurality of scan signal lines crossing the plurality of image signal lines; a gate driver circuit configured to output a scan signal to the plurality of scan signal lines, and drive the plurality of scan signal lines by the scan signal; and a control circuit configured to control the gate driver circuit through a control signal, wherein the control signal comprises voltage waveform with voltage variation cycles. When at least one of scan cycles of the scan signal is started, a voltage level of the scan signal rises from a first voltage level to a second voltage level with a curvature of a convex parabola. When at least one of the scan cycles is ended, the voltage level of the scan signal non-vertically falls from the second voltage level to the first voltage level with a curvature of a concave parabola.

It is unavoidable to form parasitic capacitance between the gate and the drain of the thin-film transistor. When the scan signal rises or falls suddenly, the thin-film transistor is turned off immediately, so that the voltage of the pixel electrode (hereafter refer to as a pixel voltage) is decreased in response to the rising offset and the falling offset of the scan signal caused by the parasitic capacitance. The rising offset or the falling offset is generated by subtracting the non-scan voltage from the scan voltage. As a result, the pixel voltage having a significant voltage offset may cause the image flashing and the display degradation problem. However, the display device of the present disclosure is able to control the rising part and the falling part of the scan signal to prevent the scan signal from suddenly rising or falling, so as to reduce the voltage offset of the pixel voltage caused by parasitic capacitance.

Furthermore, the conductive lines disposed on the transparent insulate substrate, made by glass, are not ideal paths, so the signals transmitted on the conductive lines may be delayed. The structure of the display device of the present disclosure can prevent from nonuniform display due to signal delay, and the voltage offsets of the pixel voltages caused by parasitic capacitance can be reduced to become more uniform. As a result, the display image with high performance can be obtained.

### BRIEF DESCRIPTION OF THE DRAWINGS

The structure, operating principle and effects of the present disclosure will be described in detail by way of various embodiments which are illustrated in the accompanying drawings.

FIG. 1 is a schematic view of the exemplary structure of a liquid crystal display device.

FIG. 2 is a schematic view of an exemplary structure of a scan signal line driver circuit of the present disclosure.

FIG. 3 is an equivalent circuit diagram of a display pixel in which a pixel capacitor and an auxiliary capacitor are electrically connected in parallel with a common voltage terminal of a counter electrode driver circuit, according to the present disclosure.

FIG. 4 is a waveform diagram of a driving signal of a liquid crystal display device of the present disclosure.

FIG. 5 is a curve diagram of a linear gate voltage versus drain current property of TFT.

FIG. 6 is an equivalent circuit diagram of transmission in consideration of signal transmission delay property of the scan signal line, in accordance with the present disclosure.

FIG. 7 is a waveform diagram of an output signal of the scan signal line driver circuit of an embodiment of the present disclosure.

FIG. 8 is a waveform of a scan signal near an input side terminal of scan signal line, the waveform of scan signal near the other terminal of the scan signal line, and the pixel voltages, in accordance with the present disclosure.

FIG. 9 is a schematic view of a scan signal line driver circuit of other embodiment of the present disclosure.

FIG. 10 a block diagram of a main part of a scan signal line driver circuit of alternative another of the present disclosure.

FIG. 11 is a waveform diagram of another embodiment of the present disclosure.

FIG. 12 is a waveform diagram of a main part shown in FIG. 11.

FIG. 13 is a waveform diagram of output signal of a scan signal line driver circuit of an embodiment of the present disclosure.

FIG. 14 is a waveform of scan signal near an input side terminal of the scan signal line of an embodiment of the present disclosure, the waveform of scan signal near the other terminal of the scan signal line, and the pixel voltage, in accordance with the present disclosure.

FIG. 15 is a waveform diagram of an output signal of a scan signal line driver circuit of an embodiment of the present disclosure.

FIG. 16 is a waveform of the scan signal near an input side terminal of an scan signal line of an embodiment of the present disclosure, and the waveform of scan signal near the other terminal of the scan signal line, and the pixel voltage.

FIG. 17 is a waveform diagram of an output signal of a scan signal line driver circuit of an embodiment of the present disclosure, in accordance with the present disclosure.

FIG. 18 is a waveform of a scan signal near the input side terminal of a scan signal line of an embodiment of the present disclosure, and the waveform of scan signal near the other terminal of the scan signal line, and the pixel voltage, in accordance with the present disclosure.

FIG. 19 is a waveform diagram of an output signal of a scan signal line driver circuit of an embodiment of the present disclosure.

FIG. 20 is a waveform of scan signal near the input side terminal of the scan signal line of an embodiment of the present disclosure, and the waveform of scan signal near the other terminal of the scan signal line, and the pixel voltage, in accordance with the present disclosure.

### DETAILED DESCRIPTION OF THE PREFERRED EMBODIMENTS

The following embodiments of the present disclosure are herein described in detail with reference to the accompanying drawings. These drawings show specific examples of the embodiments of the present disclosure. It is to be understood that these embodiments are exemplary implementations and are not to be construed as limiting the scope of the present disclosure in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

The technical solution of the present disclosure is performed based on the following condition: in the display device such as LCD device, an input signal is not affected by the signal delay transmission property, and the input signal is inputted into the conductive lines disposed in the transparent insulate substrate, and the waveform of the signal obtained on any position of the conductive line is the same as that of the input signal, so that the effect of variation of the signal transmitted in the conductive line is constant.

The technical solution of the present disclosure is also performed based on the following condition: according to the turning on/off property of the switch device such as TFT electrically connected to the conductive line, the waveform of the input signal and a waveform obtained on any point of the conductive line can be substantial the same, so as to decrease the voltage offset caused by parasitic capacitance.

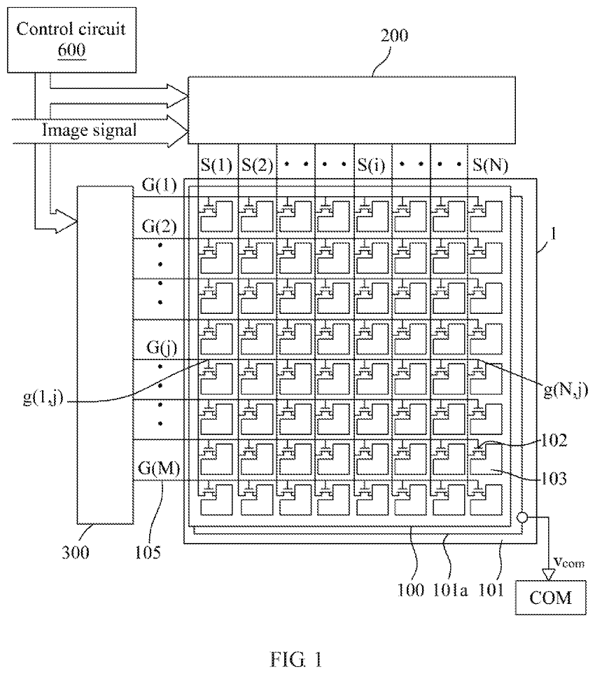

Please refer to FIG. 1. FIG. 1 is a schematic view of a structure of a liquid crystal display device of an embodiment of the present disclosure. The LCD device includes a LCD panel 1 and a driver circuit part. In the LCD panel 1, liquid crystal compositions are sealed between two electrode substrates and a deflection plate is disposed on an outer surface of the electrode substrate.

The TFT array substrate includes a transparent insulation substrate 100, and a plurality of signal lines S1, S2, . . . SN and a plurality of scan lines G1, G2 . . . GN formed on the transparent insulation substrate 100 and arranged in a matrix form. Optionally, a number of the signal lines S1, S2 . . . SN is the same as that of the scan signal lines G1, G2 . . . GN. Optimally, the transparent insulation substrate 100 can be glass. A switch device 102 is disposed at each intersection between the signal line and the scan line, and is formed by the TFT of electrically connected to the pixel electrode 103. An alignment film covers all above-mentioned components.

On the other hand, the counter substrate served as the other electrode substrate is formed by the counter electrode and the alignment film laminated with each other. Optimally, the counter substrate is made by almost completely transparent insulation substrate, for example, the glass substrate, and the counter substrate is served as the TFT array substrate. The driver circuit part includes a scan signal line driver circuit 300, a signal line driver circuit 200 and a counter electrode driver circuit COM which are electrically connected to the scan lines, the signal lines and the counter electrodes of the LCD panel. The control circuit 600 is configured to control the signal line driver circuit and the scan signal line driver circuit 300.

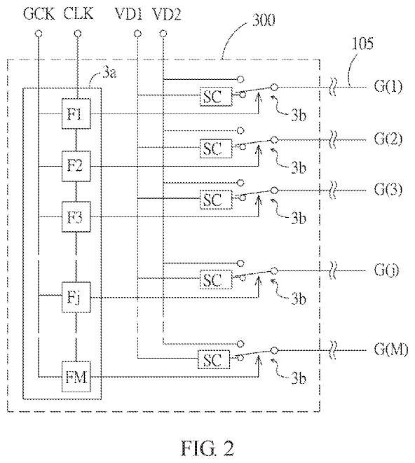

The scan signal line driver circuit 300 may be regarded as a gate driver, the scan signal line driver circuit 300 synchronously outputs the plurality of scan signals to synchronously drive the plurality of scan signal lines 105; for example, the scan signal line driver circuit 300 can be formed by a shift register part 3a and selection switches 3b. The shift register part 3a is formed by M triggers cascaded with each other, and a number of the triggers 3b is the same as that of the selection switches 3b, The selection switches 3b are turned on/off according to the output signals of the triggers, respectively, as shown in FIG. 2. One of two input ports of each selection switch 3b is heinput port VD1 configured to provide a gate starting voltage Vgh to turn on the switch device 102 (shown in FIG. 1), and the other is the input port VD configured to provide a gate off voltage Vgl to turn off the switch device 102. In response to clock signal GCK, a gate start signal GSP is transmitted sequentially through the triggers, outputted to the plurality of selection switches 3b sequentially, so that each selection switch 3b can select the voltage level Vgh to turn on the TFT and output the voltage level Vgh to the scan signal line 105 within a scan cycle (TH) period, and then output the voltage level Vgl for turning off the TFT to the scan signal line 105. As a result, the image signals outputted from the signal line driver circuit 200 to the signal lines 104 can be written into the pixels corresponding thereto, respectively. Optionally, the plurality of image signals are provided to the plurality of pixels through the plurality of signal lines 104 synchronously.

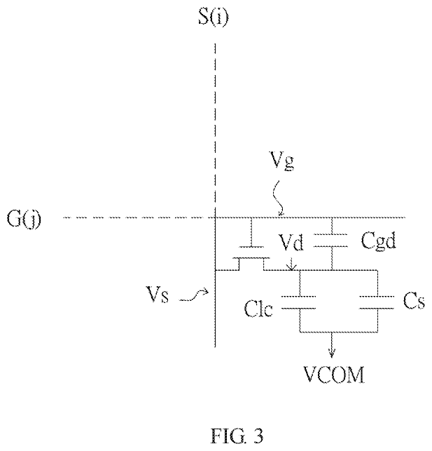

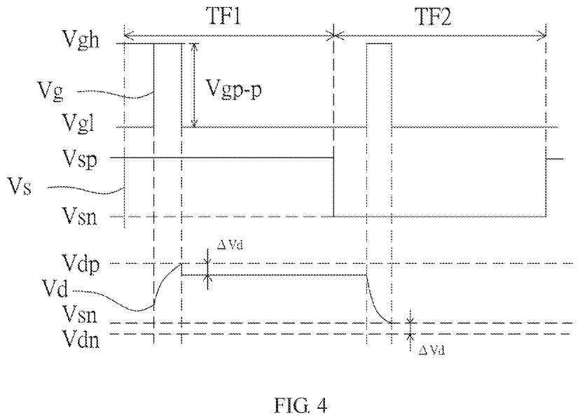

FIG. 3 shows an equivalent circuit of the display pixel P(i, j). The pixel capacitor Clc and the auxiliary capacitor Cs are electrically connected in parallel with the common voltage VCOM of the counter electrode driver circuit COM. In FIG. 3, Cgd indicates the parasitic capacitance between the gate and the drain. FIG. 4 shows a drive waveform of a conventional LCD device. As shown in FIG. 4, Vg is a voltage waveform of signal transmitted on single scan signal line, and Vs is a voltage waveform of the signal transmitted on single the signal line, and Vd is voltage waveform on the drain.

Please refer to FIGS. 1, 3 and 4, which describe conventional driving method. The liquid crystal must be driven by AC manner to prevent from aging and occurrence of residual image and image display degradation. The conventional driving method uses a frame inversion driver to perform AC driving manner. When the scan voltage Vgh, within an first period (TF1) shown in FIG. 4, is applied by the scan signal line driver circuit 300 to a gate g(i,j) of an display pixel P(i,j), the TFT is turned on, and the voltage Vsp of the image signal from the signal line driver circuit 200 can be applied to the pixel electrode through the source electrode and the drain electrode of the TFT. The voltage of the pixel electrode is maintained at the pixel voltage Vdp shown in FIG. 4 until the scan voltage Vgh is applied in next period (TF2). The voltage of the counter electrode is set as the predetermined common voltage VCOM by the counter electrode driver circuit COM, so that the liquid crystal composition sealed between the pixel electrode and the counter electrode can respond to the potential difference between the pixel voltage Vdp and the common voltage VCOM, thereby displaying an image.

Similarly, as shown in FIG. 4, when the scan voltage Vgh is applied, by the scan signal line driver circuit 300, to the gate g(i, j) of the TFT of the display pixel P(i, j) within the second period (TF2), TFT is turned on, and the image signal voltage Vsn from the signal line driver circuit 200 is written into the pixel electrode. The pixel electrode is maintained at the pixel voltage Vdn, so that the liquid crystal composition responds according to the potential difference between the pixel voltage Vdn and the common voltage VCOM, thereby driving the liquid crystal by AC manner to display image. It is unavoidable to form the parasitic capacitance Cgd between the gate and the drain of the TFT shown in FIG. 3, so when the voltage level Vgh of the scan voltage falls, the pixel voltage Vd may have a voltage offset ΔVd caused by the parasitic capacitance Cgd, as shown in FIG. 4. The non-scan voltage of the scan signal becomes Vgl when the TFT is turned off. The voltage offset ΔVd caused by the parasitic capacitance Cgd can be expressed as:

ΔVd=Cgd(Vgh−Vgl)/(Clc+Cs+Cgd)

The image flashing problem and the display degradation problem due to the voltage offset is unfavorable for the LCD device which is desired to have higher sharpness and higher performance. In the conventional solution, the common voltage VCOM of the opposite electrode is biased in advance to reduce the voltage offset ΔVd caused by the parasitic capacitance Cgd. However, it is hard to ideally arrange the scan signal lines G(1), G(2), . . . G(j), . . . G(M) without signal delay transmission, so there are certain degrees of signal delay on the scan signal lines.

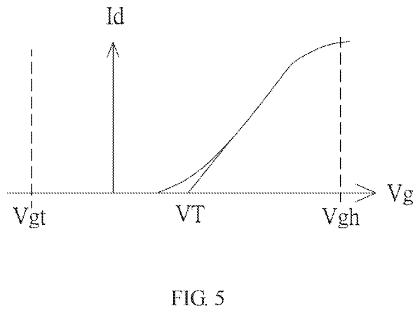

Furthermore, the TFT is unable to completely turn on/off. FIG. 5 shows a V-I property (which is also the gate voltage versus drain current property) of the TFT. In FIG. 5, voltage applied to the gate of the TFT is horizontal axis, and the current flowing through the drain is vertical axis. A scan pulse usually includes two voltage levels, one is the voltage level Vgh for turning on the TFT, and the other is the voltage level Vgl for turning off the TFT. However, as shown in FIG. 5, there is a turn on area, which is also called linear area, between the voltage levels VT and the Vgh of the TFT.

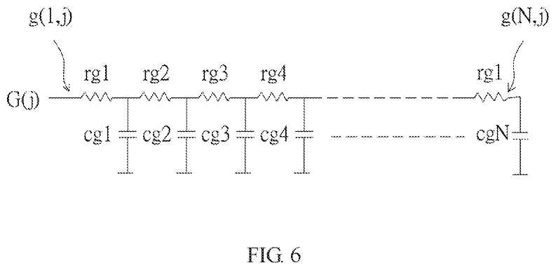

FIG. 6 is an equivalent circuit diagram of a circuit associated with the scan signal line G(j) in consideration of signal transmission delay. In FIG. 6, resistors rg1, rg2, rg3 . . . rgN express resistor components, and capacitors cg1, cg2, cg3 . . . cgN express the parasitic capacitors coupled to the scan signal line structure. The parasitic capacitance includes the crossing capacitance generated at the crossover point between the scan signal line and the signal line. As a result, the scan signal line forms the signal delay transmission path as shown in FIG. 6. The voltage offsets ΔVd caused by the parasitic capacitances Cgd in the display panel are nonuniform, so it is hard to ignore the voltage offsets caused by transmission delay in the LCD device having a larger screen and higher resolution. The conventional solution of biasing the common voltage level is unable to absorb the differences between the voltage offsets on entire display panel, so that the pixels are unable to be driven by AC field optimally, and it causes the defects of flashing and aging.

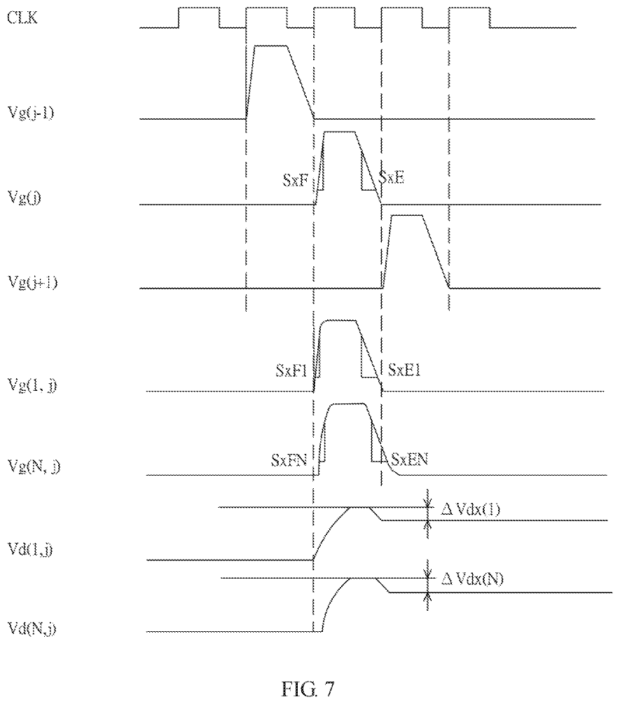

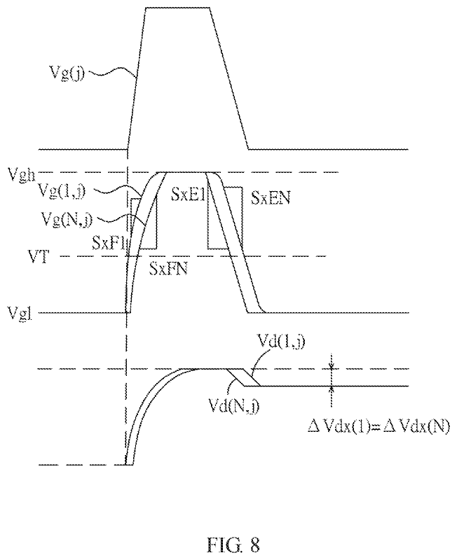

Please refer to FIGS. 7 through 12. The waveform CLK shown in FIG. 7 indicates the clock signal, and FIGS. 7 and 8 shows the waveforms of output signals VG(j−1), VG(j) and VG(j+1) of the scan signal line driver circuit of this embodiment, the waveform of scan signal Vg(l, j) is near to the input side terminal of the scan signal line, the waveform of scan signal Vg(N, j) is near the other terminal of the scan signal line, and pixel voltages Vd(l, j) and Vd(N, j) are near the front end of the scan signal line. In the waveform of the output signal VG(j) of the scan signal line driver circuit, the signal rises from non-scan voltage level Vgl to the scan voltage level Vgh with a slope of variation rate SxF, and falls from the scan voltage level Vgh to the non-scan voltage level Vgl with a slope of variation rate SxE. The variation rate is a change quantity per unit time, as shown in FIG. 1.

By setting the variation rate SxF and SxE to proper values, the variation rate SxF1 of the rising part of the waveform of the scan signal near the input side can be basically the same as the variation rate SxFN of the rising part of the waveform of scan signal near the other end, the variation rate SxE1 of the falling part of the waveform of scan signal near the input side can be basically the same as the variation rate SxEN of the falling part of the waveform of the scan signal near the other end, so that the scan signal can be prevented from being affected by the signal delay transmission property due to parasitic capacitance on the scan signal line, such as the waveform of scan signal Vg(l, j) and Vg(N, j) shown in FIGS. 7 and 8. The voltage offsets ΔVd caused by the parasitic capacitances on the scan signal line become uniform substantially in entire display panel. As a result, by using the solution of biasing the common voltage VCOM, the voltage offset ΔVd of the pixel voltage Vd caused by the parasitic capacitance Cgd on the scan signal lines can be reduced, so as to prevent the image flashing problem and the residual image problem of the display device.

In order to make the variation rates SxF1 and SxFN of rising parts of the waveforms equal to each other substantially and make the variation rates SxE1 and SxEN of falling parts of the waveforms equal to each other substantially without being affected according to the positions of the scan line, the rising part and the falling part are controlled based on the signal delay transmission property. By using the control manner, the slopes of the scan signals at different positions of the scan line can be the same substantially, so that the voltage offset of the pixel electrode can be the same substantially.

Furthermore, the manner of controlling the slopes of the rising part or falling part of the waveform can be determined upon the gate voltage versus drain current property of the TFT. In the TFT, when the gate of the TFT is applied by a voltage between the threshold voltage level range and a gate on voltage, the gate of TFT is depended on the linear variation of drain current versus the gate voltage level, and the linear variation is also called as on-resistance. In other words, TFT is at an intermediate ON state, but not at the ON state of the binary states, and the drain current varies in an analog form according to the gate voltage level.

Optionally, the slopes of the rising part and the falling part of waveforms of the scan signals can be controlled based on the gate voltage versus drain current property of TFT and the signal delay transmission property. In this condition, the slopes of the rising parts of the scan signals at any positions of the scan signal line can be the same, and the slopes of the falling parts of the scan signals at any positions of the scan signal line can be the same.

Optionally, the variation rate SxF of the sloped part from the first voltage level up to the second voltage level is different from the variation rate SxE of the sloped part from the second voltage level down to the first voltage level, as shown FIG. 7. Through the manner, the waveforms of the scan signals near the input terminal and the end terminal of the scan signal line are not affected by the signal delay transmission property parasitically formed on the scan signal line and become substantial the same, so as to reduce the voltage offsets ΔVd of the pixel voltages Vd and implement the display device without residual image problem. As a result, the voltage offsets of the pixel voltages are the same substantially and the voltage offsets are also reduced.

Furthermore, the voltage level VT shown in FIG. 8 is a threshold voltage level of the TFT shown in FIG. 7, during the period in which the scan signal falls from the scan voltage level Vgh to the threshold voltage level VT, the TFT is kept to be turned on, so there is no voltage offset caused by the parasitic capacitance Cgd; on the other hand, the voltage difference (VT−Vgl), which may cause the TFT to be turned off, on the scan signal line is affected by the parasitic capacitance Cgd, so the voltage offset occurs.

In this embodiment, when the condition VT−Vgl<Vgh−Vgl is satisfied, the differences of the voltage offsets caused by the parasitic capacitances on entire display panel can be reduced, and the voltage offsets caused by the parasitic capacitances Cgd can also be reduced.

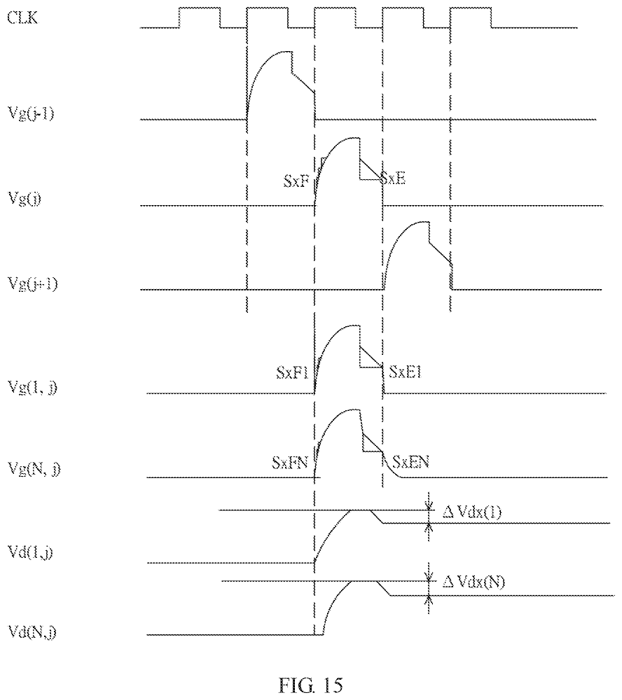

A voltage offset ΔVd(1) is a voltage offset of the pixel voltage Vd caused by the parasitic capacitance Cgd of the pixel near the terminal of the scan signal line of the scan signal line driver circuit, and voltage offset ΔVd(N) is a voltage offset of the pixel voltage on the pixel near the other terminal. The voltage offset of the pixel voltage Vd of the scan signal near the terminal of the scan signal line of the scan signal line driver circuit is ΔVdx(1), the voltage offset of the pixel voltage of the scan signal near other end is ΔVdx(N). In this condition, the variation rates SxF1 and SxFN of the rising part of the waveform are the same substantially, the variation rates SxE1 and SxFN of the rise part of the waveform are the same substantially, and the scan signal is not affected by the signal delay transmission property due to parasitic capacitance on the scan signal line, so that the voltage offsets ΔVd of the pixel voltages Vd caused by the parasitic capacitances Cgd in entire display panel become uniform and satisfy the following relationship (please refer to FIGS. 2 and 15):

ΔVdx(1)=ΔVdx(N)<ΔVd(N)<ΔVd(1)

Therefore, the regular solution of biasing the common voltage VCOM of the counter electrode, can reduce the voltage offset caused by the parasitic capacitance, so as to provide a display device having lower bias voltage level, less flashing problem and fewer display defects, thereby reducing the residual image and power consumption of the display device.

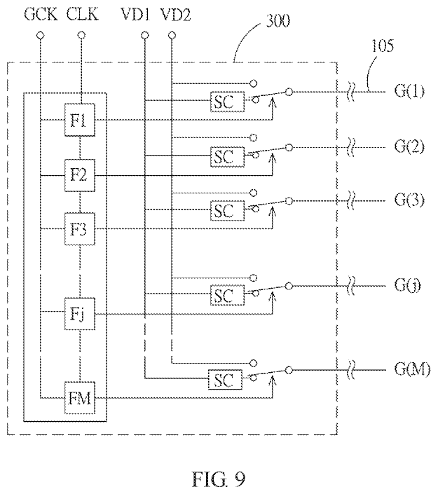

Please refer to FIG. 9. For the convenience of representation, the components of FIG. 9 the same as that of FIG. 1 are marked by the same reference number as FIG. 1.

In an embodiment of the present disclosure, similar to the scan signal line driver circuit shown in FIG. 2, the scan signal line driver circuit of FIG. 9 includes a shift register part 3a formed by M triggers (F1, F2 . . . , FM) cascaded with each other, and a plurality of selection switches 3b turned on/off according to the output signals of the triggers. Each selection switch 3b includes an input terminal VD1 to provide a gate on voltage level Vgh to turn on the TFT, and an input terminal VD2 to provide a gate off voltage level Vgl to turn off the TFT. The common end of each switch 3b is electrically connected to the scan signal line 105.

In response to the clock signal (CLK), the gate start signals (GSP) are transmitted sequentially through the triggers, and outputted to the plurality of selection switches 3b sequentially. Within a scan cycle (TH), each selection switch 3b selects the voltage level Vgh to turn on the TFT, and outputs the voltage level Vgh to the scan signal line 105, and then selects the voltage level Vgl to turn off the TFT and outputs the voltage level Vgl to the scan signal line 105.

Each slew rate control element SC disposed between the selection switch 3b and the input terminal VD2 is equivalent to an output impedance control element for controlling impedance of each output terminal of the gate driver, and is configured to increase the output impedance only during the rising and falling parts of the scan signal. The gate off voltage level outputted to the scan signal line can make the output waveform of the gate driver smoother. It can reduce the difference between the rising speed and falling speed of the waveforms in the display panel, and the waveform smoothness of the transmission property of the scan signal line are balanced with each other. As a result, the voltage offset Vd caused by the parasitic capacitance Cgd can be suppressed to make the voltage offsets through entire display panel are the same. The rising and falling parts of the gate off voltage level are also called as the rising and falling parts of the scan signal hereafter.

On the other hand, the present disclosure does not limit the structure of the slew rate control element SC which can be any component capable of changing the output impedance to change the rising and falling speeds. For example, the well-known control technology of controlling the gate voltage level of the MOS transistor component to adjust impedance can be used to implement the slew rate control element SC.

Furthermore, the impedance is increased only when the scan signal rises or falls, so that the rising and falling parts of the waveform can become smooth in this embodiment; however, according to the panel structure, the output impedance can be increased only when the scan signal rises or falls, and being kept at the increased impedance unless the gate off voltage level Vgl is outputted after the scan signal line falls and other display defect occurs because of the high impedance.

In the embodiment, the slew rate control element SC is added in the conventional structure of the scan signal line driver circuit (that is, the gate driver), to control the rising and falling speeds (slope) of the scan signal. However, in this condition, the conventional inexpensive gate driver must be also provided with extra slew rate control element SC; in this case, this solution is not benefit.

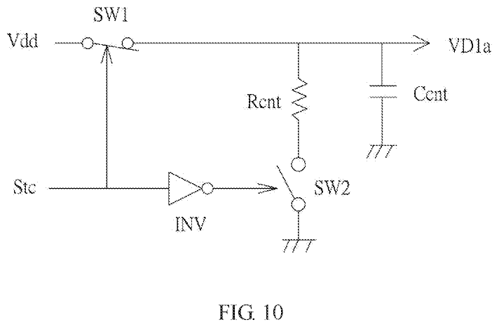

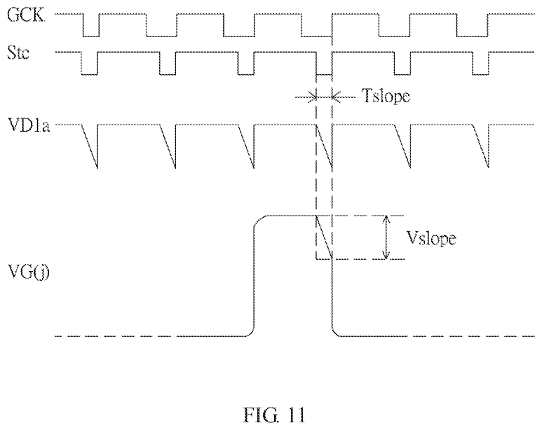

Please refer to FIGS. 10 and 11. FIGS. 10 and 11 illustrate the condition that the conventional inexpensive gate driver is applied.

FIG. 2 shows the conventional gate driver. As shown in FIG. 2, the gate driver provides the gate on voltage level Vgh and the gate off voltage level Vgl, and in response to the clock signal CLK, the gate driver outputs the gate on voltage level Vgh to the scan signal line 105, that is, the gate driver selects a row within a scan cycle (TH), and the gate driver then outputs the scan off voltage level Vgl to turn off the TFTs. On the other hand, in this embodiment, the circuit shown in FIG. 10 outputs the voltage level Vgh for the scan signal line driver circuit.

The signal voltage Vdd is applied to a terminal of the switch SW1. The signal voltage Vdd is a DC voltage having the same voltage level with the voltage Vgh and can turn on the TFT. The other terminal of the switch is electrically connected to a terminal of the resistor Rcnt and a terminal of the capacitor Ccnt. The other terminal of the resistor Rcnt is grounded through the switch SW2. The signal Stc (shown in FIG. 11) provided from the inverter INV is used to turn on/off the switch SW2. The signal Stc generated by the control component (not shown in figures) is synchronous with each scan cycle, and used to turn on/off the switch SW1. The signal Stc is synchronous with the clock signal (CLK), as shown in FIG. 10. For example, the signal Stc can be generated by a monophonic multivibrator (not shown in figures).

When the signal Stc is at the second voltage level, the switch SW1 is turned on, the capacitor Ccnt is charged according to the signal Stc, which is served as charge control signal; and the switch SW2 is turned off when being applied the first voltage level by the inverter INV. On the other hand, when the signal Stc is at the first voltage level (that is, the discharge control signal), the switch SW1 is turned off, the switch SW2 is applied the second voltage level by the inverter INV to turn off. In FIG. 1, as shown in FIG. 10. The switches SW1 and SW2 are the second voltage level activation components.

The output signal VD1a generated by above-mentioned circuit is transmitted to the input terminal VD1 of the scan signal line driver circuit 300 shown in FIG. 2. The signal Stc is a timing signal used to control the rising time and the falling time of the scan signal (that is also the voltage on the gate), and as shown in FIG. 11, the signal Stc is synchronous with each scan cycle (TH).

According to the structure, when the signal Stc is at the second voltage level, the switch SW1 is turned on and the switch SW2 is turned off, the output signal VD1a served as the voltage level Vgh is outputted to the input terminal VD1 of the signal line driver circuit 300. On the other hand, when the signal Stc is at the first voltage level, the switch SW1 is turned off, the switch SW2 is turned on at the same time, so the capacitor Ccnt is discharged through the resistor Rcnt and the voltage level is falling gradually. As a result, the output signal VD1a has the waveform as shown in FIG. 5.

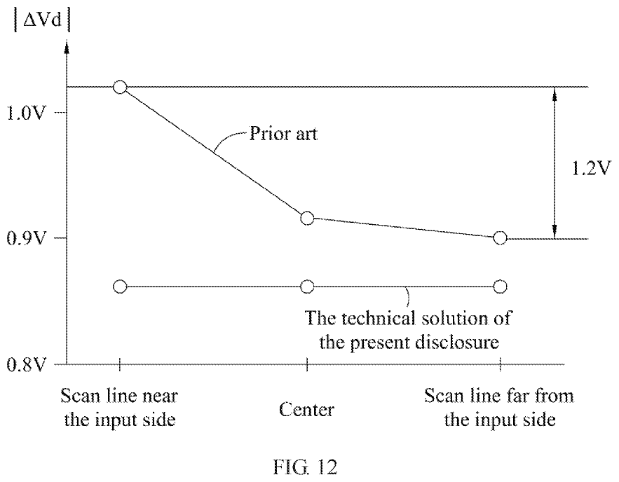

When the output signal VD1a (shown in FIG. 10) generated by the circuit of FIG. 12 is transmitted to the input terminal VD1 of the scan signal line driver circuit 300, the waveform of the scan signal starts to fall, such as the waveform VG(j) shown in FIG. 4. The first voltage level cycle of the signal Stc can be changed to adjust the sloped time of the waveform, and the resistance value of the resistor Rcnt and the capacitance of the capacitor Ccnt can be changed to adjust the slope Vslope, to adjust the time constant of the circuit, thereby optimizing the display panel.

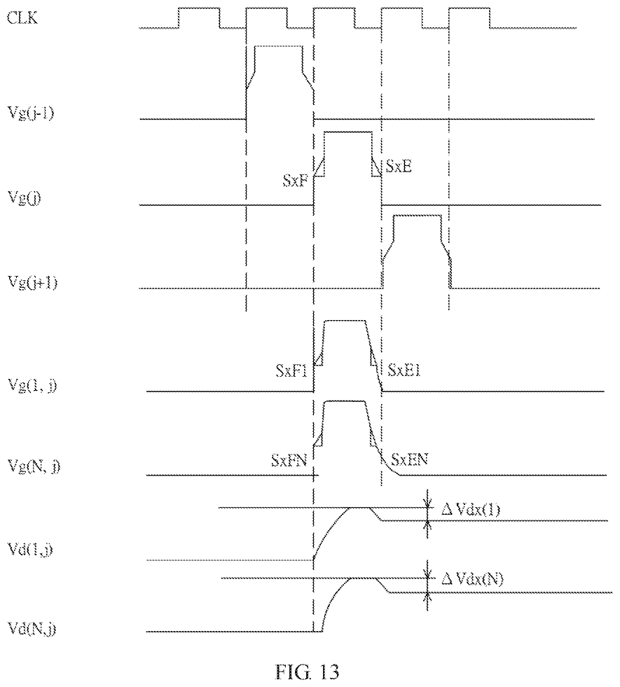

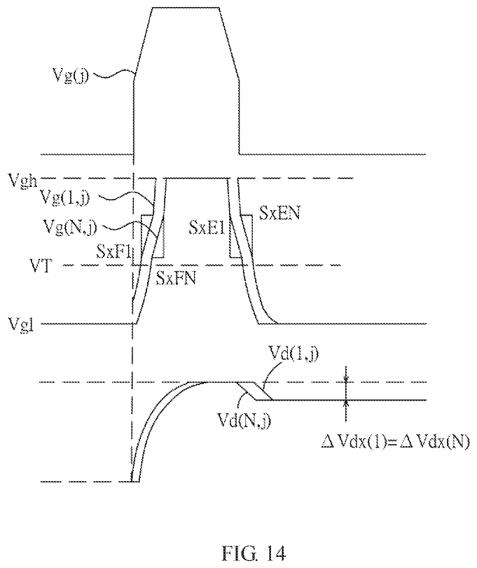

FIGS. 13 and 14 show the output waveform VG(j−1), VG(j) and VG(j+1) of the scan signal line driver circuit of the embodiment of present disclosure. The waveform of scan signal Vg(l, j) is near to the input side terminal of the scan signal line, and the waveform of scan signal Vg(N, j) is near the other terminal of the scan signal line. The pixel voltages Vd(l, j) and Vd(N, j) are near the front end of the scan signal line. In the waveform of the output signal VG(j) of the scan signal line driver circuit, the signal rises from the non-scan voltage Vgl to the scan voltage Vgh with a slope of the variation rate SxF, and falls from the scan voltage Vgh to the non-scan voltage Vgl with a slope of variation rate SxE. The variation rate is a change quantity per unit time, as shown in FIG. 13.

In this embodiment, the scan signal is controlled to rise or fall in an enable period, as shown in FIG. 13, and the variation rates SxF and SxE can be properly set to control the rising part and the falling part of the waveform.

More specifically, the waveform generated by the gate driver includes an upwardly-sloped part varied from the first voltage level up to the second voltage level non-vertically, a horizontal part maintained at the second voltage level, and a downwardly-sloped part varied from the second voltage level down to the first voltage level non-vertically. In order to achieve the objective, the variation rates SxF and SxE must be set properly to make the variation rate SxF1 of the rising part of the waveform of the scan signal near the input side the same as the variation rate SxFN of the rising part of the waveform of scan signal near the other end, the variation rate SxE1 of the falling part of the waveform of scan signal near the input side the same as the variation rate SxEN of the falling part of the waveform of the scan signal near the other end, so that the scan signal is not affected by the signal delay transmission property due to parasitic capacitance on the scan signal line, such as the waveform of scan signal Vg(l, j) and Vg(N, j) (please refer to FIGS. 13 and 14). Similarly, the voltage offsets ΔVd of the pixel voltages Vd caused by the parasitic capacitance Cgd on the scan signal line in entire display panel become uniform substantially.

In order to make the variation rate SxF1 and SxFN of the rising parts of the waveforms equal to each other substantially and make the variation rate SxE1 and SxEN of the falling parts of the waveforms equal to each other substantially at any positions of scan line, the rising part and the falling part can be controlled based on the signal delay transmission property. By using above-mentioned control manner, the slope of the scan signal at different positions of the scan line can be the same substantially, thereby making the voltage level shift of the pixel electrode the same substantially.

Furthermore, the slopes of the rising part or falling part of the waveform can also be controlled based on the gate voltage versus the drain current property of the TFT. When the gate of the TFT is applied by a voltage between the threshold voltage level range and a gate on voltage level, the state of the TFT is depended on the linear variation of the drain current versus the gate voltage level, and the linear variation is also called as on-resistance. In other words, TFT is not at the turn on state of the binary states, and is at the intermediate ON state, and the drain current varies in an analog form according to the gate voltage level.

In this embodiment, when the TFT is at the linear variation state (that is, the intermediate ON state), the rising slope and the falling slope of the scan signal can be controlled to affect the slope. The control manner causes the scan signal to rise and fall with higher slope, and the TFT is linearly changed from the turn on state to the turn off state according to the voltage-current property, so that the voltage offset of each pixel voltage caused by the parasitic capacitance can be reduced.

Optionally, the voltage level of the waveform of the scan signal can be controlled based on the signal delay transmission and the gate voltage versus drain current property of the TFT, and the waveform includes an upwardly-sloped part varied from the first voltage level up to the second voltage level non-vertically, a horizontal part maintained at the second voltage level, and a downwardly-sloped part varied from the second voltage level down to the first voltage level non-vertically. In this condition, the waveforms of the scan signals near the input terminal and end terminal of the scan signal line are not affected by the signal delay transmission property of the parasitic capacitance on the scan signal line, and become substantial the same, so as to reduce the voltage offset ΔVd of the pixel voltage Vd. By using above-mentioned manner, the waveforms of the scan signals near the input terminal and the terminal of the scan signal line are not affected by the signal delay transmission property parasitically formed on the scan signal line, and can become substantial the same to reduce the voltage offsets ΔVd of the pixel voltages Vd. As a result, the voltage offsets of the pixel voltage are the same substantially to reduce the voltage offset, and the display device without residual image problem can be implemented.

Furthermore, the voltage level VT shown in FIG. 14 is the threshold voltage level shown in FIG. 13. During the period in which the scan signal falls from the scan voltage Vgh to the threshold voltage level VT, TFT is kept to be turned on, so there is no voltage offset caused by the parasitic capacitance Cgd. On the other hand, the voltage difference (VT−Vgl), which may cause the TFT to be turned off, on the scan signal line is affected by the parasitic capacitance Cgd, so the voltage offset occurs.

In this embodiment, the condition VT−Vgl<Vgh−Vgl can be satisfied, so the difference between the voltage offsets caused by the parasitic capacitance in entire display panel can be reduced, and the voltage offsets caused by the parasitic capacitance Cgd can also be reduced.

The voltage offset ΔVd(1) is the voltage offset of the pixel voltage Vd caused by the parasitic capacitance Cgd of the pixel near the terminal of the scan signal line of the scan signal line driver circuit, and the voltage offset ΔVd(N) is the voltage offset of the pixel voltage of the pixel near the other terminal. The voltage offset ΔVd of the pixel voltage Vd of the scan signal near the terminal of the scan signal line of the scan signal line driver circuit is ΔVdx(1), the voltage offset of the pixel voltage of the scan signal near other terminal is ΔVdx(N). In this condition, the variation rates SxF1 and SxFN of the rising part of the waveform are the same substantially, and the variation rates SxE1 and SxFN of the rise part of the waveform are the same substantially, and the scan signal is not affected by the signal delay transmission property due to parasitic capacitance on the scan signal line, so that the voltage offsets ΔVd of the pixel voltages Vd caused by the parasitic capacitance Cgd in entire display panel become uniform, and satisfy the following relationship (please refer to FIGS. 2 and 15):

ΔVdx(1)=ΔVdx(N)<ΔVd(N)<ΔVd(1)

Therefore, the regular solution of biasing the common voltage VCOM of the counter electrode can reduce the voltage offset caused by the parasitic capacitance and provide the display device having lower bias voltage level, less flashing problem and fewer display defects, for example, such display device has less residual image and lower power consumption.

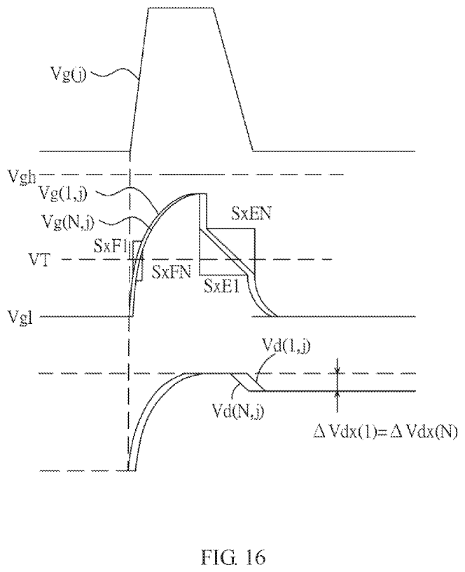

FIGS. 15 and 16 shows the output waveform VG(j−1), VG(j) and VG(j+1) of the scan signal line driver circuit of this embodiment. The waveform of scan signal Vg(l, j) is near to the input side terminal of the scan signal line, the waveform of scan signal Vg(N, j) is near the other terminal of the scan signal line, and the pixel voltages Vd(l, j) and Vd(N, j) are near the front terminal of the scan signal line. In the waveform of the output signal VG(j) of the scan signal line driver circuit, the signal rises from non-scan voltage Vgl to the scan voltage Vgh with a slope of the variation rate SxF, and falls from the scan voltage Vgh to the non-scan voltage Vgl with a slope of variation rate SxE. The variation rate is a change quantity per unit time, as shown in FIG. 15.

In this embodiment, the scan signal is controlled to rise and fall in the enable period, as shown in FIG. 15. The variation rates SxF and SxE can be properly set to control the rising part and the falling part of the waveform.

More specifically, the waveform generated by the gate driver includes an upwardly-sloped part varied from the first voltage level to the second voltage level with a curvature of a convex parabola, and a downwardly-sloped part varied from the second voltage level down to the first voltage level non-vertically. In order to achieve the objective, the variation rates SxF and SxE must be set properly, to make the variation rate SxF1 of the rising part of the waveform of the scan signal near the input side terminal the same as the variation rate SxFN of the rising part of the waveform of scan signal near the other terminal, and make the variation rate SxE1 of the falling part of the waveform of scan signal near the input side terminal the same as the variation rate SxEN of the falling part of the waveform of the scan signal near the other terminal, so that the scan signal is not affected by the signal delay transmission property due to parasitic capacitance on the scan signal line, such as the waveform of scan signal Vg(l, j) and Vg(N, j) (please refer to FIGS. 15 and 16). Similarly, the voltage offsets of the pixel voltage Vd caused by the parasitic capacitance Cgd on the scan signal line in entire display panel become uniform substantially.

In order to make the variation rates SxF1 and SxFN of the rising parts of the waveforms equal to each other substantially, and make the variation rates SxE1 and SxEN of the falling parts of the waveforms equal to each other substantially, and the scan signals are not affected according to the position thereof on the scan line, the rising part and the falling part are controlled based on the signal delay transmission property. By using the control manner, the slope of the scan signal at different positions of the scan line can be the same substantially, thereby making the voltage offsets of the pixel voltages on the pixel electrodes the same substantially.

Furthermore, the manner of controlling slopes of the rising part or falling part of the waveform can be determined based on the gate voltage versus the drain current property of the TFT. When the gate of the TFT is applied by a voltage between the threshold voltage level range and a gate on voltage level, the state of the TFT is depended on the linear variation of the drain current versus the gate voltage level, and the linear variation is also called as on-resistance. In other words, TFT is not at the turn on state of the binary states, and is at the intermediate ON state. The drain current varies in an analog form according to the gate voltage level.

In this embodiment, by controlling the rising slope and the falling slope of the scan signal, the slope can be affected when the TFT is at the linear variation state (that is, the intermediate ON state). The control manner causes the scan signal to rise and fall with the slope, the TFT is linearly changed from the turn on state to the turn off state according to the voltage-current property, so that the voltage offset of each pixel voltage caused by the parasitic capacitance can be reduced.

Optionally, in a scan cycle, the variation rate SxF of the rising part of the waveform is controlled to vary over time, for example, from high to low, and the variation rate SxE of the falling part of the waveform can be controlled to only occur at the downwardly-sloped part of the scan signal from the second voltage level down to the first voltage level non-vertically, so that the waveforms of the scan signals near the input terminal and the end terminal of the scan signal line are not affected by the signal delay transmission property parasitically formed on the scan signal line, and become substantial the same, thereby reducing the voltage offset of the pixel voltage Vd, to implement the display device without residual image problem. As a result, the voltage offsets of the pixel voltage are the same substantially and also reduced.

Furthermore, the voltage level VT shown in FIG. 16 is the threshold voltage of TFT shown in FIG. 15, and during the period in which the scan signal falls from the scan voltage Vgh to the threshold voltage level VT, the TFT is kept to be turned on, so there is no voltage offset caused by the parasitic capacitance Cgd. On the other hand, the voltage difference (VT−Vgl), which may turn off the TFT, on the scan signal line is affected by the parasitic capacitance Cgd, so the voltage offset occurs.

In this embodiment, the difference between the voltage offsets caused by the parasitic capacitance in entire display panel can be reduced, and the voltage offsets caused by the parasitic capacitance Cgd can also be reduced.

The voltage offset ΔVd(1) is the voltage offset of the pixel voltage Vd of the pixel near the terminal of the scan signal line caused by the parasitic capacitance Cgd, and the voltage offset ΔVd(N) is a voltage offset of the pixel voltage of the pixel near other end, so that the voltage offset of the pixel voltage Vd of the scan signal near the terminal of the scan signal line of the scan signal line driver circuit is ΔVdx(1), and the voltage offset of the pixel voltage of the scan signal near other end is ΔVdx(N). In this condition, the variation rates SxF1 and SxFN of the rising parts of the waveforms are the same substantially, and the variation rates SxE1 and SxFN of the rise parts of the waveforms are the same substantially, and it indicates that the scan signals are affected by the signal delay transmission property due to parasitic capacitance on the scan signal line. The voltage offsets of the pixel voltages Vd caused by the parasitic capacitance Cgd in entire display panel can become uniform and satisfy the following relationship (please refer to FIGS. 15 and 16):

ΔVdx(1)=ΔVdx(N)<ΔVd(N)<ΔVd(1)

By using the regular solution of biasing the common voltage VCOM of the counter electrode, to reduce the voltage offset caused by the parasitic capacitance can be reduced, so as to provide a display device having a lower bias voltage level and less flashing problem and fewer display defects, for example, the display device has the reduced residual image and lower power consumption.

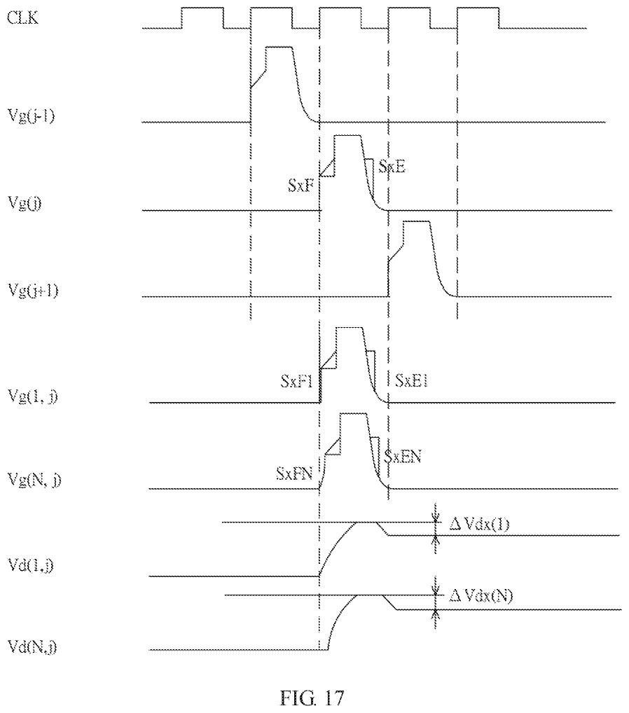

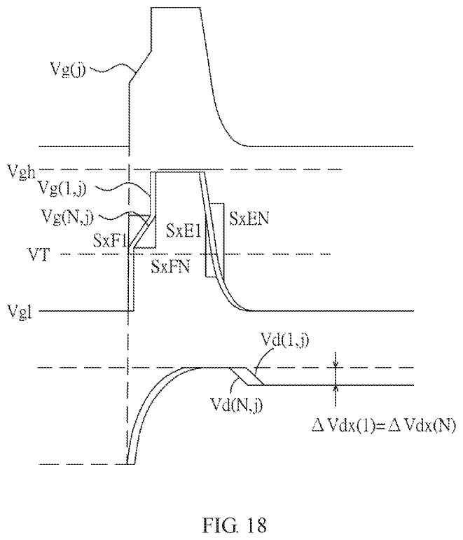

FIGS. 17 and 18 show the output waveform VG(j−1), VG(j) and VG(j+1) of the scan signal line driver circuit of the embodiment of the present disclosure. The waveform of scan signal Vg(l, j) is near the input side terminal of the scan signal line, the waveform of scan signal Vg(N, j) is near the opposite terminal of the scan signal line, and pixel voltages Vd(l, j) and Vd(N, j) are near the front terminal of the scan signal line. In the waveform of the output signal VG(j) of the scan signal line driver circuit, the signal rises from non-scan voltage Vgl to the scan voltage Vgh with a slope of the variation rate SxF, and falls from the scan voltage Vgh to the non-scan voltage Vgl with a slope of variation rate SxE.The variation rate is a change quantity per unit time, as shown in FIG. 17.

In this embodiment, the scan signal is controlled to rise and fall in the enable period, as shown in FIG. 17. The variation rate SxF and SxE can be properly set to control the rising part and the falling part of the waveform. More specifically, the waveform generated by the gate driver includes an upwardly-sloped part varied from the first voltage level up to the second voltage level non-vertically, and a downwardly-sloped varied from the second voltage level down to the first voltage level with a curvature of a concave parabola, as shown in FIG. 17. In order to form above-mentioned waveform, the variation rate SxF and SxE must be set properly, so that the variation rate SxF1 of the rising part of the waveform of the scan signal near the input side can be basically the same as the variation rate SxFN of the rising part of the waveform of scan signal near the other end, and the variation rate SxE1 of the falling part of the waveform of scan signal near the input side can be basically the same as the variation rate SxEN of the falling part of the waveform of the scan signal near the other end, and it indicates that the scan signal is prevented from being affected by the signal delay transmission property due to parasitic capacitance on the scan signal line, such as the waveform of scan signal Vg(l, j) and Vg(N, j) shown in FIGS. 17 and 18. Similarly, the voltage offsets of the pixel voltages Vd caused by the parasitic capacitance Cgd on the scan signal line in entire display panel become uniform substantially.

In order to make the variation rate SxF1 and SxFN of the rising parts of the waveforms equal to each other substantially, and make the variation rate SxE1 and SxEN of the falling parts of the waveforms equal to each other substantially, and prevent the scan signal from being affected by the position of scan line, the rising part and the falling part can be controlled based on the signal delay transmission property. By using the control manner, the slope of the scan signal at different positions of the scan line can be the same substantially, thereby making the voltage level shift of the pixel electrode the same substantially.

Furthermore, the manner of controlling slopes of the rising part or falling part of the waveform can be determined upon the gate voltage versus the drain current property of the TFT. When the gate of the TFT is applied by a voltage between the threshold voltage level range and a gate on voltage level, the state of the TFT is depended on the linear variation of the drain current versus the gate voltage level, and the linear variation is also called as on-resistance. In other words, TFT is not at the turn on state of the binary states, and is at the intermediate ON state, the drain current varies in an analog form according to the gate voltage level.

In this embodiment, the rising slope and the falling slope of the scan signal can be controlled to affect the slope when the TFT is at the linear variation state (that is, the intermediate ON state). The control manner causes the scan signal to rise and fall with the slopes, and the TFT is linearly changed from the turn on state to the turn off state according to the voltage-current property, so that the voltage offset of each pixel voltage caused by the parasitic capacitance can be reduced. Optionally, in a scan cycle, the variation rate SxF of the rising part can be controlled to only occur at the upwardly-sloped part of the scan signal from the first voltage level up to the second voltage level non-vertically, and control the variation rate SxE of the falling part of the waveform to vary over time, for example, from low to high. As a result, in an end portion of a scan cycle, the scan signal has the downwardly-sloped part falling from the second voltage level to the first voltage level with a curvature of the concave parabola. The waveforms on the scan signal line near the input terminal and the terminal of the scan signal line can be prevented from being affected by the signal delay transmission property parasitically formed on the scan signal line, and become substantial the same; furthermore, the voltage offsets of the pixel voltages Vd are also reduced, so as to implement the display device without residual image problem. As a result, the voltage offsets of the pixel voltage are the same substantially, and the voltage offsets are reduced.

Furthermore, the voltage level VT shown in FIG. 18 is the threshold voltage of the TFT shown in FIG. 17. During the period in which the scan signal falls from the scan voltage Vgh to the threshold voltage level VT, the TFT is kept to be turned on, so there is no voltage offset caused by the parasitic capacitance Cgd. On the other hand, the voltage difference (VT−Vgl), which may cause the TFT to be turned off, on the scan signal line is affected by the parasitic capacitance Cgd, so the voltage offset occurs. Furthermore, this embodiment satisfies the condition: VT−Vgl<Vgh−Vgl, so the difference between the voltage offsets caused by the parasitic capacitance in entire display panel can be reduced, and the voltage offsets caused by the parasitic capacitance Cgd can be reduced. In this condition, the variation rates SxF1 and SxFN of the rising part of the waveform are the same substantially, and the variation rates SxE1 and SxFN of the rise part of the waveform are the same substantially, and the scan signal can be prevented from being affected by the signal delay transmission property due to parasitic capacitance on the scan signal line, so that the voltage offsets of the pixel voltages Vd caused by the parasitic capacitance Cgd in entire display panel become uniform, and satisfy the following relationship (please refer to FIGS. 2 and 15):

ΔVdx(1)=ΔVdx(N)<ΔVd(N)<ΔVd(1)

By using the regular solution of biasing the common voltage VCOM of the counter electrode, the voltage offset caused by the parasitic capacitance can be reduced, so as to provide the display device having a lower bias voltage level, less flashing problem and fewer display defects, for example, the residual image and power consumption of the display device can be reduced.

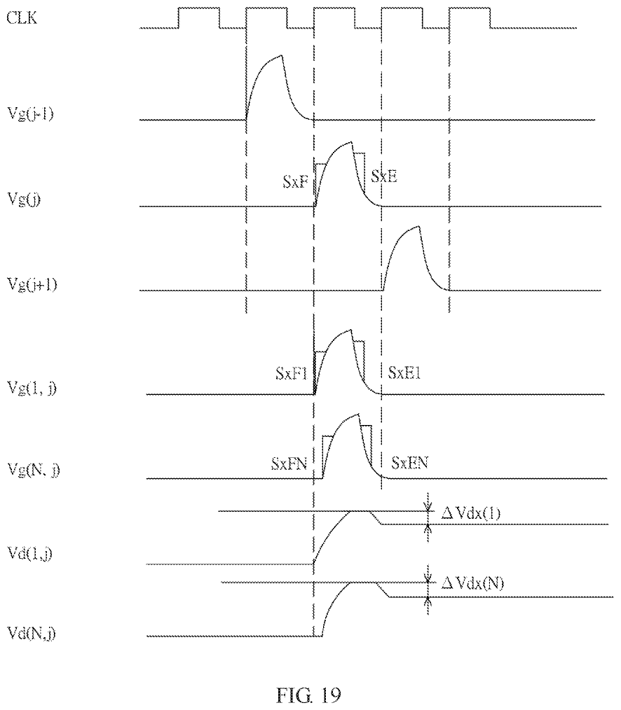

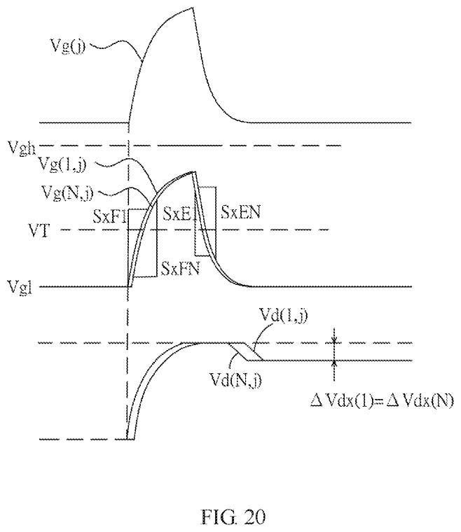

FIGS. 19 and 20 shows the output waveforms VG(j−1), VG(j) and VG(j+1) of the scan signal line driver circuit of this embodiment of the present disclosure. The waveform of scan signal Vg(l, j) is near the input side terminal of the scan signal line, the waveform of scan signal Vg(N, j) is near the other terminal of the scan signal line, and the pixel voltages Vd(l, j) and Vd(N, j) are near the front terminal of the scan signal line. In the waveform of the output signal VG(j) of the scan signal line driver circuit, the signal rises from non-scan voltage Vgl to the scan voltage Vgh with the slope of the variation rate SxF, and falls from the scan voltage Vgh to the non-scan voltage Vgl with the slope of variation rate SxE. The variation rate is a change quantity per unit time, as shown in FIG. 19.

As shown in FIG. 19, in this embodiment, the scan signal is controlled to rise and fall in the enable period, and the variation rate SxF and SxE can be properly set to control the rising part and the falling part of the waveform. More specifically, the waveform generated by the gate driver rises from the first voltage level up to the second voltage level with a curvature of a convex parabola, and falls from the second voltage level down to the first voltage level with a curvature of the concave parabola. In order to form such waveform, the variation rate SxF and SxE must be set properly, to make the variation rate SxF1 of the rising part of the waveform of the scan signal near the input side the same as the variation rate SxFN of the rising part of the waveform of scan signal near the other end, and make the variation rate SxE1 of the falling part of the waveform of scan signal near the input side the same as the variation rate SxEN of the falling part of the waveform of the scan signal near the other end, so that the scan signal can be prevented from being affected by the signal delay transmission property due to parasitic capacitance on the scan signal line, such as the waveform of scan signal Vg(l, j) and Vg(N, j) shown in FIGS. 19 and 20. Similarly, the voltage offsets of the pixel voltage Vd caused by the parasitic capacitance Cgd on the scan signal line in entire display panel can become uniform substantially.

In order to make the variation rate SxF1 and SxFN of rising parts of the waveforms equal to each other substantially, and make the variation rate SxE1 and SxEN of falling parts of the waveforms equal to each other substantially, and the scan signal is prevented from being affected at different positions of scan line, the rising part and the falling part can be controlled based on the signal delay transmission property. By using the control manner, the slopes of the scan signals at different positions of the scan line can be the same substantially, so as to make the voltage offsets of the pixel voltages of the pixel electrodes the same substantially. Furthermore, the manner of controlling slopes of the rising part or falling part of the waveform can be determined upon the gate voltage versus the drain current property of the TFT. When the gate of the TFT is applied by a voltage between the threshold voltage level range and a gate on voltage level, the state of the TFT is depended on the linear variation of the drain current versus the gate voltage level, and the linear variation is also called as on-resistance. In other words, TFT is not at the turn on state of the binary states, is at the intermediate ON state, the drain current varies in an analog form according to the gate voltage level.

In this embodiment, the rising slope and the falling slope of the scan signal can be controlled to affect the slope when the TFT is at the linear variation state (that is, the intermediate ON state). The control manner causes the scan signal to rise and fall with slope, and the TFT is linearly changed from the turn on state to the turn off state according to the voltage-current property, so that the voltage offset of each pixel voltage caused by the parasitic capacitance can be reduced. Optionally, in a scan cycle, the variation rate SxF of the rising part of the waveform is controlled to vary over time, for example, from high to low, at the front end of the scan cycle, so that the scan signal can have an upwardly-sloped part rising from the first voltage level to the second voltage level with the curvature of convex parabola; furthermore, and the variation rate SxE of the falling part of the waveform is controlled to vary over time, for example, from low to high, so that, in an end portion of a scan cycle, the scan signal can have a downwardly-sloped part falling from the second voltage level to the first voltage level with a curvature of the concave parabola. As a result, the voltage offset ΔVd of the pixel voltage Vd can be reduced, and the waveforms of the scan signal near the input terminal and the end terminal of the scan signal line can be prevented from being affected by the signal delay transmission property parasitically formed on the scan signal line and can become substantial the same, so as to reduce the voltage offsets of the pixel voltages Vd, thereby implementing the display device without residual image problem. As a result, the voltage offsets of the pixel voltage are the same substantially, and can be reduced.

Furthermore, the voltage level VT shown in FIG. 18 is the threshold voltage of the TFT shown in FIG. 1. During the period in which the scan signal falls from the scan voltage Vgh to the threshold voltage level VT, the TFT is kept to be turned on, so there is no voltage offset caused by the parasitic capacitance Cgd; on the other hand, the voltage difference (VT−Vgl), which may cause the TFT to be turned off, on the scan signal line is affected by the parasitic capacitance Cgd, so the voltage offset occurs. Furthermore, this embodiment satisfies the condition: VT−Vgl<Vgh−Vgl, so the difference between the voltage offsets caused by the parasitic capacitance in entire display panel can be reduced, and the voltage offsets caused by the parasitic capacitance Cgd can also be reduced.

In this condition, the variation rates SxF1 and SxFN of the rising part of the waveform can be the same substantially, and the variation rates SxE1 and SxFN of the rise part of the waveform can be the same substantially, and the scan signal can be prevented from being affected by the signal delay transmission property due to parasitic capacitance on the scan signal line, so that the voltage offsets of the pixel voltage Vd caused by the parasitic capacitance Cgd in entire display panel can become uniform, and satisfy the following relationship (please refer to FIGS. 2 and 15):

ΔVdx(1)=ΔVdx(N)<ΔVd(N)<ΔVd(1)

By using the regular solution of biasing the common voltage VCOM of the counter electrode, the voltage offset caused by the parasitic capacitance can be reduced to provide the display device having a lower bias voltage level and less flashing problem and fewer display defects, for example, the residual image and the power consumption of the display device can be reduced.

In the display device of the present disclosure, the scan signal line driver circuit controls the scan signal line to fall, so that the voltage offsets of the pixel voltages in entire display panel can become uniform substantially. The voltage offset is caused by the parasitic capacitance on the scan signal line. The falling part of the waveform of the scan signal can vary with the variation rate Sx. The variation rate Sx of the scan signal near the input side terminal of the scan signal line is set as Sx1, like the waveform Vg(l, j) and Vg(N, j), and the variation rate Sx1 is same as the variation rate SxN of the scan signal near other end, so that the scan signals can be prevented from being affected by the signal delay transmission property of the scan signal line.

In the embodiments, the display device is applicable to liquid crystal display device, OLED display device, QLED display device, curved display device or other display device; however, the present disclosure is not limited thereto.

The present disclosure disclosed herein has been described by means of specific embodiments. However, numerous modifications, variations and enhancements can be made thereto by those skilled in the art without departing from the spirit and scope of the disclosure set forth in the claims.

1. A display device, comprising:
a plurality of pixels arranged in a matrix form;
a plurality of image signal lines configured to provide a plurality of data signals to the plurality of pixels;
a plurality of scan signal lines crossing the plurality of image signal lines;
a gate driver circuit configured to output a scan signal to the plurality of scan signal lines, and drive the plurality of scan signal lines by the scan signal; and
a control circuit configured to control the gate driver circuit through a control signal, wherein the control signal comprises voltage waveform with voltage variation cycles;
wherein when at least one of scan cycles of the scan signal is started, a voltage level of the scan signal non-vertically rises from a first voltage level to a second voltage level, and the voltage level of the scan signal is maintained at the second voltage levels, and when at least one of the scan cycles is ended, the voltage level of the scan signal non-vertically falls from the second voltage level to the first voltage level.

2. The display device according to claim 1, wherein the control circuits inputs the control signal to the gate driver circuit, to change a part of the variation between the second voltage level and the first voltage level of the scan signal.

3. The display device according to claim 1, wherein the voltage level of the scan signal non-vertically rises from the first voltage level to the second voltage level with a first slope, and the voltage level of the scan signal non-vertically falls from the second voltage level to the first voltage level with a second slope, and the first slope is higher than the second slope.

4. The display device according to claim 1, wherein the voltage level of the scan signal non-vertically rises from the first voltage level to the second voltage level with a first slope, and the voltage level of the scan signal non-vertically falls from the second voltage level to the first voltage level with a second slope, and the first slope is lower than the second slope.

5. The display device according to claim 1, wherein the gate driver circuit comprises a shift register part formed by a plurality of triggers cascaded with each other, and a plurality of selection switches turned on or off respectively according to output signals of the plurality of triggers.

6. The display device according to claim 5, wherein a number of the triggers is the same as that of the selection switches.

7. The display device according to claim 5, wherein, in response to a clock signal, a plurality of gate start signals are transmitted through the plurality of triggers sequentially and outputted to the plurality of selection switches sequentially, to turn off the plurality of selection switches sequentially.

8. The display device according to claim 5, wherein the control circuit comprises a plurality of slew rate control components disposed between the plurality of selection switches and the plurality of triggers respectively, and configured to control impedances of output terminals of the gate driver, to increase the output impedances only during rising and falling parts of the scan signals.

9. The display device according to claim 1, further comprising a capacitor electrically connected to an input terminal of the gate driver, and a voltage source electrically connected to the input terminal of the gate driver through a first switch, and a resistor electrically connected in parallel with the capacitor through a second switch.

10. The display device according to claim 9, wherein the control circuit comprises an inverter configured to control turning on/off operation of the first switch through a charge-discharge control signal which is inverted by the inverter to control the turning on/off operation of the second switch.

11. (canceled)

12. (canceled)

13. (canceled)

14. A display device, comprising:
a plurality of pixels arranged in a matrix forms;
a plurality of image signal lines configured to provide a plurality of data signals to the plurality of pixels;
a plurality of scan signal lines crossing the plurality of image signal lines;
a gate driver circuit configured to output a scan signal to the plurality of scan signal lines, to drive the plurality of scan signal lines;
a control circuit configured to control the gate driver circuit through a control signal, wherein the control signal comprises voltage waveform with the voltage variation cycle; and
a capacitor electrically connected to an input terminal of the gate driver, wherein a voltage source electrically connected to the input terminal of the gate driver through a first switch, and a resistor electrically connected in parallel with the capacitor through a second switch;
wherein when at least one of scan cycles of the scan signal is started, a voltage level of the scan signal non-vertically rises from a first voltage level to a second voltage level, and the voltage level of the scan signal is maintained at the second voltage level, and when at least one of the scan cycles is ended, the voltage level of the scan signal non-vertically falls from the second voltage level to the first voltage level;
wherein the control circuit comprises an inverter configured to control turning on/off operation of the first switch through a charge-discharge control signal, and the charge-discharge control signal is inverted by the inverter to control turn on/off operation of the second switch, and when the charge-discharge control signal is at the second voltage level, the first switch is turned on, and the second switch is turned off by the first voltage level applied by the inverter, so that the capacitor is charged, and when the charge-discharge control signal is at the second voltage level, the first switch is turned off, and the second switch is turned on by the first voltage level applied by the inverter, so that the capacitor is discharged.

15. The display device according to claim 14, wherein the voltage level of the scan signal non-vertically rises from the first voltage level to the second voltage level with a first slope, and the voltage level of the scan signal non-vertically falls from the second voltage level to the first voltage level with a second slope, and the first slope is higher than the second slope.

16. The display device according to claim 14, wherein a number of the plurality of image signal lines is the same as a number of the plurality of scan signal lines.

17. The display device according to claim 14, wherein the plurality of the data signals are synchronously provided to the plurality of pixels through the plurality of image signal lines.

18. The display device according to claim 14, wherein the gate driver circuit synchronously outputs the plurality of scan signals to drive the plurality of scan signal lines synchronously.

19. The display device according to claim 14, further comprising a counter electrode driver circuit, wherein a pixel capacitor and an auxiliary capacitor of each of the plurality of pixels are electrically connected in parallel with to a common voltage terminal of the counter electrode driver circuit.

20. A display device, comprising:
a plurality of pixels arranged in a matrix forms;
a plurality of image signal lines configured to provide a plurality of data signals to the plurality of pixels;
a plurality of scan signal lines crossing the plurality of image signal lines;
a gate driver circuit configured to output the plurality of scan signals to the plurality of scan signal lines, to drive the plurality of scan signal lines;
a control circuit configured to control the gate driver circuit through a control signal, wherein the control signal comprises a voltage waveform level with voltage variation cycles; and
a capacitor electrically connected to the input terminal of the gate driver, a voltage source electrically connected to the input terminal of the gate driver through the first switch, the resistor electrically connected in parallel with the capacitor through the second switch;
wherein when at least one of scan cycles of the scan signal is started, the voltage level of the scan signal non-vertically rises from the first voltage level to the second voltage level, and the voltage level of the scan signal is maintained at the second voltage level, and when at least one of scan cycles is ended, the voltage level of the scan signal non-vertically falls from the second voltage level to the first voltage level;
wherein the control circuits inputs the control signal to the gate driver circuit, to change a part of the variation between the second voltage level and the first voltage level of the scan signal;
wherein the voltage level of the scan signal non-vertically rises from the first voltage level to the second voltage level with a first slope, and the voltage level of the scan signal non-vertically falls from the second voltage level to the first voltage level with a second slope, and the first slope is higher than the second slope, and the first slope is different from the second slope;
wherein the gate driver circuit comprises a shift register part formed by a plurality of triggers cascaded with each other, and the plurality of selection switches are turned on or off respectively according to output signals of the plurality of triggers.

21. A display device, comprising:
a plurality of pixels arranged in a matrix form;
a plurality of image signal lines configured to provide a plurality of data signals to the plurality of pixels;
a plurality of scan signal lines crossing the plurality of image signal lines;
a gate driver circuit configured to output a scan signal to the plurality of scan signal lines, and drive the plurality of scan signal lines by the scan signal; and
a control circuit configured to control the gate driver circuit through a control signal, wherein the control signal comprises voltage waveform with voltage variation cycles;
wherein when at least one of scan cycles of the scan signal is started, a voltage level of the scan signal rises from a first voltage level to a second voltage level with a curvature of a convex parabola;
wherein when at least one of the scan cycles is ended, the voltage level of the scan signal non-vertically falls from the second voltage level to the first voltage level.

22. A display device, comprising:
a plurality of pixels arranged in a matrix form;
a plurality of image signal lines configured to provide a plurality of data signals to the plurality of pixels;
a plurality of scan signal lines crossing the plurality of image signal lines;
a gate driver circuit configured to output a scan signal to the plurality of scan signal lines, and drive the plurality of scan signal lines by the scan signal; and
a control circuit configured to control the gate driver circuit through a control signal, wherein the control signal comprises voltage waveform with voltage variation cycles;
wherein when at least one of scan cycles of the scan signal is started, a voltage level of the scan signal non-vertically rises from a first voltage level to a second voltage level;
wherein when at least one of the scan cycles is ended, the voltage level of the scan signal non-vertically falls from the second voltage level to the first voltage level with a curvature of a concave parabola.

23. A display device, comprising:
a plurality of pixels arranged in a matrix form;
a plurality of image signal lines configured to provide a plurality of data signals to the plurality of pixels;
a plurality of scan signal lines crossing the plurality of image signal lines;
a gate driver circuit configured to output a scan signal to the plurality of scan signal lines, and drive the plurality of scan signal lines by the scan signal; and
a control circuit configured to control the gate driver circuit through a control signal, wherein the control signal comprises voltage waveform with voltage variation cycles;
wherein when at least one of scan cycles of the scan signal is started, a voltage level of the scan signal rises from a first voltage level to a second voltage level with a curvature of a convex parabola;
wherein when at least one of the scan cycles is ended, the voltage level of the scan signal non-vertically falls from the second voltage level to the first voltage level with a curvature of a concave parabola
